(19) United States
(12) Patent Application Publication
(10) Pub. No.: US 2012/0155333 A1
(43) Pub. Date: Jun. 21, 2012

(54) APPRATUS AND METHOD FOR LAWFUL INTERCEPTION

(75) Inventors: Byungsik YOON, Daejeon (KR); Song In Choi, Daejeon (KR); Manho Park, Daejeon (KR); Junghak Kim, Daejeon (KR); Jung Been Lee, Seoul (KR); Do Hoon Kim, Seoul (KR); Taehoon Um, Seoul (KR); Hoh Peter In, Seoul (KR)

(73) Assignee: Electronics and Telecommunications Research Institute of Daejeon, Daejeon (KR)

(21) Appl. No.: 13/294,618

(22) Filed: Nov. 11, 2011

(30) Foreign Application Priority Data
Dec. 17, 2010 (KR) 10-2010-0130173
Apr. 7, 2011 (KR) 10-2011-003232

(51) Int. Cl. H04L 12/16

(52) U.S. Cl. 370/259

(57) ABSTRACT

A lawful interception apparatus activates, invocates, and terminates a lawful interception using a SIP (session initiation protocol) message that is transmitted and received between a terminal to be intercepted and an IP multimedia subsystem.

### CROSS-REFERENCE TO RELATED APPLICATION

This application claims priority to and the benefit of Korean Patent Application Nos. 10-2010-0130173 and 10-2011-0032321 filed in the Korean Intellectual Property Office on Dec. 17, 2010 and Apr. 7, 2011, the entire contents of which are incorporated herein by reference.

### BACKGROUND OF THE INVENTION

(a) Field of the Invention

The present invention relates to a method and apparatus for lawful interception. More particularly, the present invention relates to a method and apparatus for IMS (IP multimedia subsystem)-based lawful interception.

(b) Description of the Related Art

According to recent rapid development of mobile communication and the Internet, it is required to provide mobile subscribers with various high quality multimedia services.

IP multimedia subsystem (IMS) refers to a structure that can smoothly provide mobile subscribers with IP (internet protocol)-based packet service, which enables the subscribers to simultaneously use non-real-time services such as file transmission, e-mail transmission, and short message service as well as real-time services such as voice transmission and image transmission, or supports new services using these services, for example, a variety of services such as voice communication (VoIP) and IPTV, VOD (video on demand), MOD (music on demand), instant messaging, emergency telephone, location service, and presence service.

IMS does not refer to a specified service but refers to a framework or a service infrastructure with which various multimedia services are utilized more efficiently.

The greatest merit of the IMS is that it can reduce the cost to develop each multimedia service.

The IMS modularizes and standardizes infrastructures that are commonly used various services or applications so that it is possible to prevent overlapped development and save costs.

While it is conventionally required that systems for billing or authentication, session control, and subscriber authentication are separately prepared for a specified service, the IMS commonly uses the systems and finally adds application(s) for a specified service only, so that it has an excellent cost saving effect and a high synergy effect when operating multiple services.

IMS divides existing network construction into a G PRS (general packet radio service)-based packet switched service domain and an IP multimedia service domain in order to increase efficiency of multimedia services.

That is, since the IMS has a construction in which the packet switched service domain and the IP multimedia service domain are separated from each other, differently from an existing wireless that simply consists of the packet switched service domain, so that it is needed to continuously delegate a right of lawful interception between them.

FIG. 1 is a drawing illustrating a structure of a lawful interception in the art.

As illustrated in FIG. 1, a network business management unit 2 in a network business domain is requested to intercept through a HI1 (handover interface 1), that is a standardized interface from an interception LEMF (law enforcement monitoring facility) 5 in an LEA (law enforcement agency) such as the prosecutors office or police, and commands an HF (internal interception function) unit 1 that performs an interception to intercept an object to be intercepted.

The IIF unit 1 is positioned on a network node, and generates IRI (intercept related information) and CC (contents of communication) to transfer them to an IRI-MF (IRI-mediation function) unit 3 and a CC-MF unit 4 in the network business domain.

The IRI-MF unit 3 and the CC-MF unit 4 transmit the IRI and CC to an LEMF 5 through standardized interfaces, that is, an HI2 (handover interface 2) and an HI3 (handover interface 3), respectively.

To give an interception right to lawfully intercept in such a wired network or a fixed wireless network (wired or WLAN) means that the LEA permits the network business to perform the interception after receiving a warrant issued from the court.

Further, it is not easy to issue a warrant in such a manner to be applied to a continuous interception performance in various mobile wireless networks where a user dynamically moves, and it is not easy for an object to be intercepted to continuously delegate an interception right since basic information for interception is performed only between the LEMF 5 and the network business.

Meanwhile, the ETSI DTS 102 677 v0.2.2 (2009-12): Lawful Interception (LI) Dynamic Triggering of Content of Communication Interception Standard specifies an IMS structure in which a single packet switched network service domain and an IP multimedia service business domain are separated from each other.

The standard illustrates a structure where, in a case that the IP multimedia service business and the packet switched network service business are different from each other, the IP multimedia service business can delegate the interception right to the packet switched network service business even when using the same IMS service, and suggests a method where the IP multimedia service business can delegate the interception right in real-time even when the packet switched network service business is changed as the user moves.

However, since there is no detailed method describing what server in the IMS should embody what interception function and when the interception should be activated, invocated, and finished, study of a detailed interception technique reflecting characteristics of the IMS is needed.

### SUMMARY OF THE INVENTION

The technical object of the present invention is to provide a method and apparatus for a lawful interception reflecting characteristics of an IMS.

An exemplary embodiment of the present invention provides a method for performing a lawful interception in an IP multimedia subsystem where an IP multimedia service domain and a network service domain are separated from each other.

A lawful interception method includes steps of capturing a SIP message transmitted from a terminal that uses an IMS service to be intercepted, and determining at least one of activation, invocation, and termination of the lawful interception of the terminal to be intercepted using the SIP message.

The determining step may include the steps of registering a URI (uniform resource identifier) of the terminal to be intercepted when a SIP registration message, used to register the terminal to be intercepted into the IP multimedia service domain by the terminal to be intercepted, was captured.

The SIP registration message is captured in a P-CSCF (proxy-call session control function) of the IP multimedia subsystem.

Further, the determining step may include the step of invocating the lawful interception in a case that a SIP session setting message used to set a session for an IP multimedia service of the terminal to be intercepted was captured.

At this time, the SIP session setting message is captured in an S-CSCF (serving-CSCF) of the IP multimedia subsystem.

Further, the determining step may include the step of capturing a SIP session termination message indicating a termination of session, thereby terminating the lawful interception, in the S-CSCF (serving-CSCF) of the IP multimedia subsystem. The terminating step may include the steps of transferring the SIP session termination message to the terminal to be intercepted, in the S-CSCF, through the P-CSCF in a case that a timer corresponding to an expiration time allocated in the first SIP registration message is timed out and a re-registration is not performed, and, and capturing the ISP NOTIFY message in the S-CSCF.

According to another exemplary embodiment of the present invention, an apparatus for performing a lawful interception in an IP multimedia subsystem in which an IP multimedia service domain and a network service domain are separated from each other is provided.

The apparatus for performing a lawful interception may include an interception administration function unit, an interception information internal collection function unit, and an interception content trigger function unit.

The interception administration function unit may capture a first SIP message of a user terminal to be intercepted and transfer an activation command of a lawful interception.

The interception information internal collection function unit may generate a user terminal related IRI according to an activation command of the lawful interception and transfer the IRI to an interception monitoring apparatus, capture a second SIP message of the user terminal and command invocation of the lawful interception, and capture a third SIP message of the user terminal and command termination of the lawful interception.

Further, an interception content trigger function unit may transfer invocation and termination of the lawful interception to the network service domain.

The interception administration function unit may be included in a P-CSCF (proxy-call session control function) of the IP multimedia subsystem.

The interception information internal collection function unit and the interception content trigger function unit may be included in the S-CSCF (serving-CSCF) of the IP multimedia subsystem.

The apparatus for performing a lawful interception may further include an interception content internal collection function unit to intercept the communication content according to an invocation of the lawful interception and transfer the communication content to a monitoring apparatus, and to terminate the lawful interception according to the termination of the lawful interception. At this time, the interception content internal collection function may include in the in the network service domain.

### BRIEF DESCRIPTION OF THE DRAWINGS

FIG. 1 is a drawing illustrating a lawful interception structure in the art.

FIG. 2 is a drawing illustrating communication network construction of an IMS according to an exemplary embodiment of the present invention.

FIG. 3 is a drawing illustrating an IMS shown in FIG. 2.

FIG. 4, FIG. 5A, and FIG. 5B are drawings schematically illustrating lawful interception apparatuses in an IMS structure, respectively, according to an exemplary embodiment of the present invention.

FIG. 6 is a drawing illustrating a precondition for use of an IMS service.

FIG. 7 is a drawing illustrating interception activation in a lawful interception method according to an exemplary embodiment of the present invention.

FIG. 8 is a process flowchart of a SIP message to perform interception activation in an AF of a P-CSCF according to an exemplary embodiment of the present invention.

FIG. 9 is a drawing illustrating an IMS-based interception implementation method according to an exemplary embodiment of the present invention.

FIG. 10 is a process flowchart of a SIP message to perform a communication content interception implementation in an S-CSCF according to an exemplary embodiment of the present invention.

FIG. 11 is a drawing illustrating an IMS-based interception termination method according to an exemplary embodiment of the present invention.

FIG. 12 is a drawing illustrating another embodiment of an IMS-based lawful interception method according to an exemplary embodiment of the present invention.

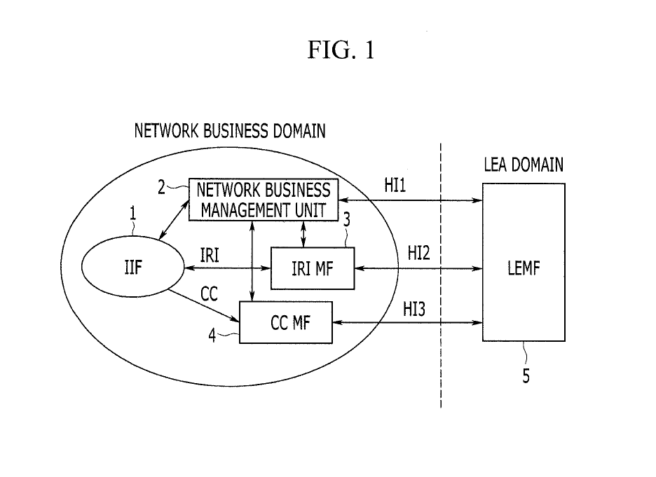

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout specification and claims, unless explicitly described to the contrary, the word “comprise” and variations such as “comprises” or “comprising” will be understood to imply the inclusion of stated elements but not the exclusion of any other elements.

In this specification, a terminal may denote a mobile station (MS), a mobile terminal (MT), a subscriber station (SS), a portable subscriber station (PSS), user equipment (UE), and an access terminal (AT), and may include functions of all or a part of the terminal, the mobile terminal, the subscriber station, the portable subscriber station, the user equipment, and the access terminal.

Hereinafter, a method and apparatus for lawful interception according to an exemplary embodiment of the present invention will be described in detail with reference to the accompanying drawings.

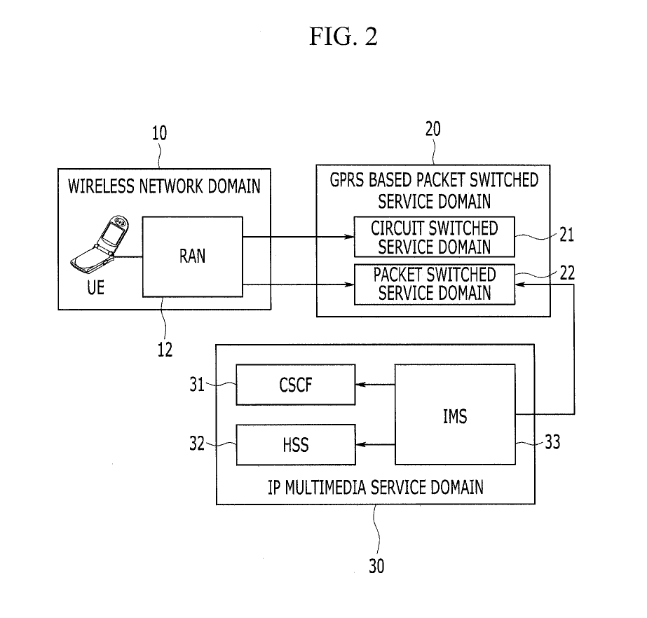

FIG. 2 is a drawing illustrating a communication network construction of an IMS according to an exemplary embodiment of the present invention.

Referring to FIG. 2, in an IMS (IP multimedia subsystem), an IP network is divided into a wireless network domain 10, a GPRS (general packet radio service)-based packet switched service domain 20, and an IP multimedia service domain 30.

The wireless network domain 10 is constructed of nodes such as a user terminal UE that is an IMS service user and a RAN (radio network controller) 12 serving to access the user terminal UE through a radio section.

The GPRS-based packet switched service domain 20 is constructed of an SGSN (not shown) and a gateway GPRS support node GGSN (not shown) that provide services of transferring packet data between the wireless network domain 10 and the external network or IP multimedia service domain 30, managing mobility of the user terminal UE, and activating a PDP context.

Such a GPRS-based packet switched service domain 20 may include a circuit switched service domain 21 and a packet switched service domain 22.

The IP multimedia service domain 30 may include a CSCF (call session control function) 31 serving to process registration and a multimedia call using a SIP (session initiation protocol) developed by LETF, an HSS (home subscriber server) 32 that provides an HLR (home location register) function of an existing mobile network and a function of mobility management and authentication of an IMS service user, and an IMS 33.

Further, the IP multimedia service domain 30 has a media gateway control function to make signaling and call control interlock with an existing PSTN (public switched telephone network), and a multimedia resource function for GGSN and bearer control to provide a multiple multimedia conference service.

The media gateway takes charge of a packet bearer circuit and a packet media stream channel.

The IMS 33 standardizes all IP network reference models including the CSCF 31 and HSS 32.

The IMS 33 controls a common session to provide an IMS service between heterogeneous networks, and uses an SIP that is a common protocol to control the same.

The SIP is a protocol that was originally developed to implement a multimedia conference or a remote class using Internet technology in a university campus or a local IP network.

Multimedia communication between terminals connected to an IP network is referred to a session, and the SIP has functions to initiate, terminate, and control the session.

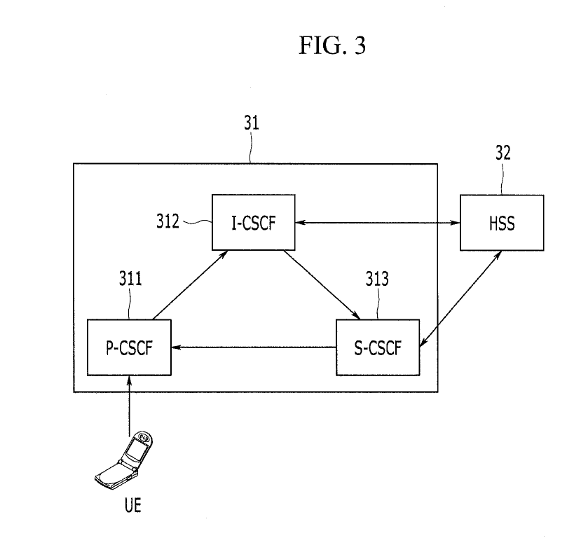

FIG. 3 is a drawing illustrating the CSCF shown in FIG. 2.

Referring to FIG. 3, the CSCF 31 is divided into a P-CSCF (proxy-CSCF) 311, an I-CSCF (interrogating CSCF) 312, and an S-CSCF (serving CSCF) 313, and a SIP is used as a communication protocol among them.

The P-CSCF 311 is the first point that user terminal UE accesses the IMS 33 and exists in the same domain as the GGSN.

When the user terminal UE needs to obtain an address of the P-CSCF 311 to be accessed, it can obtain the address using a DHCP (dynamic host configuration protocol) or through a PDP context activation procedure of the GPRS.

Further, the P-CSCF 311 transfers the SIP registration message received from the user terminal UE to the I-CSCF 312 with reference to a home domain of the user terminal UE, and manages an address of the S-CSCF 313 obtained in the process of the SIP registration message.

Further, the P-CSCF 311 transfers the SIP session set message received from the user terminal UE to the S-CSCF 313 using the address of the S-CSCF 313 obtained in the process of the SIP registration message.

The I-CSCF 312 is the first point to which a home network IMS of the user is accessed, and many I-CSCFs may exist in one network domain.

However, the IMS service to be used by the user may be determined by the home domain of the user terminal UE.

The home network of the user means an IP multimedia service domain used by the IMS user when he or she uses the IMS service, and the home domain of the user terminal UE may mean the packet switched service domain 20 used by the user.

The I-CSCF 312 provides a connection between an SLF (subscription locator function, not shown) and the HSS 32.

When the I-CSCF 312 has received the SIP registration message, it selects the HSS 32 using the SLF, receives the address of the S-CSCF 313 from the HSS 32, and assigns the S-CSCF 313 that will actually take charge of the registration.

Further, the I-CSCF 312 routes the SIP message to the S-CSCF 313.

The S-CSCF 313 acts like a registrar that is a constituent element of the SIP protocol in the IMS 33.

The S-CSCF 313 is a subsystem that controls the session of the IMS service user, which registers subscribers in the HSS 32, downloads subscriber information, and stores and manages a service profile.

Further, the S-CSCF 313 manages a session state of the registered user, and performs a control service.

The HSS 32 is a centered database that performs functions such as user registration and change management, authentication, authorization, session routing, and billing, and several HSSs 32 may exist in one network domain.

Further, the SLF provides information used to select any one HSS among a plurality of HSSs.

That is, the SLF acts to provide the I-CSCF 312 with an address of a proper HSS when a plurality of HSSs are operated in the network.

Further, the SLF performs a user mobility management through the circuit switched service domain 21, the packet switched service domain 22, and the IMS 33.

An interface among the P-CSCF 311, the I-CSCF 312, and the S-CSCF 313 is performed using the SIP protocol, and an interface between the I-CSCF 312 and the HSS 32, and between the S-CSCF 313 and the HSS 32, is performed using a Diameter protocol.

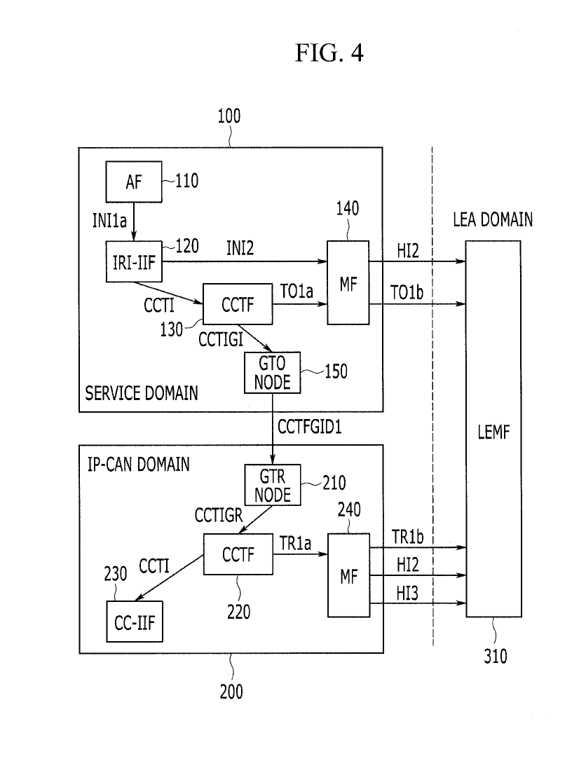

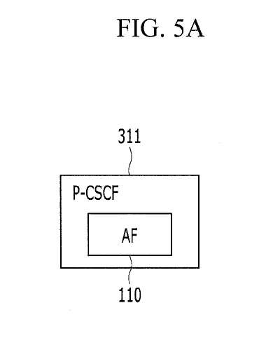

FIG. 4, FIG. 5A, and FIG. 5B are drawings schematically illustrating an IMS-based lawful interception apparatus according to an exemplary embodiment of the present invention.

In the IMS, an IMS service user accesses various access networks so that the user is provided with the IMS service using an interaction with the access network and the IP multimedia service network.

Accordingly, the network business and the IMS service business are functionally separated from each other.

In FIG. 4, a service domain 100 is similar or identical to the IP multimedia service domain 33 in FIG. 2, which is a domain of the IP multimedia service business like the IMS.

An IP-CAN (IP-connectivity access network) domain 200 is similar or identical to the GPRS-based packet switched service domain 20 in FIG. 2, which is a domain of a packet switched network business to access IP.

Referring to FIG. 4, a lawful interception apparatus in the IMS structure in which the service domain 100 and the IP-CAN domain 200 are separated from each other may include a lawful interception AF (administration function) unit 110, an IRI-IIF (intercept related information-internal interception function) unit 120, a CCTF (content of communication trigger function) unit 130, an MF (mediation function) unit 140, a GTO (gateway triggering origination) node 150, a GTR (gateway triggering receiving) node 210, a CCTF unit 220, a CC-HF (CC-internal interception function) unit 230, and an MF unit 240.

Further, the lawful interception apparatus may further include a LEMF (law enforcement monitoring facility) 310 that is an interception monitoring apparatus in an LEA (law enforcement agency).

An AF unit 110, an IRI-IIF unit 120, a CCTF unit 130, an MF unit 140, and a GTO node unit 150 may exist in the service domain 100, and a GTR node 210, a CCTF unit 220, a CC-IIF unit 230, and an MF unit 240 may exist in an IP-CAN domain 200.

Particularly, as shown in FIG. 5A, the AF unit 110 may be included in the P-CSCF 311, and as shown in FIG. 5B, the IRI-IIF unit 120, the CCTF unit 130, and the MF unit 140 may be included in the S-CSCF 313.

The AF unit 110 commands the IRI-IIF unit 120 to lawfully intercept an object to be intercepted through an internal network interface INI1a in order to perform an interception requested by the LEMF 310.

Result data of the lawful interception include the IRI and CC.

The IRI is communication-related information, which may include signaling information for communication of an object to be intercepted, information on receiver and transmitter (IP or AC address, telephone number, and so on), and information on the number of communications, periods, and times, and the CC may include voice, video, and data that are contents of communication.

The IRI-IIF unit 120 generates an IRI of an object to be intercepted in the service domain 100, and transfers the IRI to the LEMF 310 using the MF unit 140 through an internal network interface INI2.

Further, the IRI-IIF unit 120 can perform a TOF (triggering origination function) that can delegate an interception right in real-time, and can include a TOF unit to perform this function.

The TOF unit of the IRI-IIF 120 generates a dynamic triggering command to delegate a real-time interception right according to an interception command of the AF 110, and transfers the command to the CCTF unit 130 through a CCTI (content of communication triggering interface).

The CCTF unit 130 transfers the dynamic triggering command of the CC to a TRF (triggering receiving function) unit of the CC-HF unit 230 through a CCCI (content of communication control interface) in order to capture the communication session to be intercepted.

Further, the CCTF 130 transfers the dynamic triggering command to the LEMF 310 through the MF unit 140.

At this time, the communication with the CCTF unit 130 and the MF unit 140 is performed through a triggering initiation interface T01a, and the communication with the MF unit 140 and the LEMF 310 is performed through a triggering initiation interface TO1b.

Such a dynamic triggering command may include interception commands to implement or stop the interception for identifier and CC of the IP-CAN domain 200.

The GTO node 150 and the GTR node 210 act as an inlet/outlet at each domain for the dynamic triggering command, the GTO node 150 transfers the dynamic triggering command received from the CCTF unit 130, and the GTR node 210 transfers the command to the TRF unit of the CC-IIF 230 through the CCTF unit 220.

The CCTF unit 130 transfers the dynamic triggering command to the GTO node 150 through a CCTIGI (content of communications triggering interface gateway initiating) message, and the GTR node 210 transfers the dynamic triggering command to the CCTF unit 220 through a CCTIGR message.

Further, the GTO node 150 can transfer the dynamic triggering command to the GTR node 210 through a CCTFGID1 (content of communications triggering function gateway internal domain 1) message.

Differently from this, the GTO node 150 can transfer a dynamic triggering command to the GTR node 210 through a TTP (trusted third party).

The TRF unit of the CC-HF unit 230 receives the dynamic triggering command and the CC-IIF unit 230 implements an interception of the CC that is related with the object to be intercepted.

The CC-IIF unit 230 generates the CC that is related with the object to be intercepted and transfers the CC to the LEMF 310 through the MF unit 240.

The GTO node 150 and the GTR node 210 are in charge of concealing identifiers of the nodes related with the internal network structure and dynamic triggering included in a security domain of the internal business network from all external nodes.

At this time, even in a network of a single business, the service domain 100 and the IP-CAN domain 200 may be embodied in different security domains from each other.

Since the dynamic triggering is generated in a business network, the GTO node 150 and the GTR node 210 directly communicate through a CCTFGID1 message.

Accordingly, it can be assumed that a warrant issuance between CCTF units 130 and 220 in each business domain 100 and 200 is absolutely trusted.

If a business has a common CCTF unit in two domains 100 and 200 and the only MF units are separated, the interface related with the GTO node 150 and the GTR node 210 is not needed, and a CCTF unit can communicate with a TOF unit of the IRI-IIF unit 120 and a TRF unit of the CC-IIF unit 230. Further, when a business has a common MF unit in two domains 100 and 200 and only the CCTF units are separated, the interfaces TR1a and Tr1b are not needed.

That is, since the interfaces TR1a and Tr1b provide the LEMF 310 with similar information provided by the interfaces TO1a and TO1b in a single business, the interfaces TR1a and Tr1b are not needed.

However, as shown in FIG. 4, in a case that a plurality of MF units 140 and 240 and a plurality of CCTF units 130 and 220 exist, interception data of the service domain 100 and the IP-CAN domain 200 are transferred to the LEMF 310 through handover points of different physical networks.

Accordingly, the interfaces TR1a and Tr1b provide information available in the IP-CAN domain 200, and the interfaces TO1a and TO1b provide information available in the service domain 100.

Available information may include information on the service domain that transferred the dynamic triggering command in the IP-CAN domain 200 and the IP-CAN domain to which the dynamic triggering command will be transferred in the service domain 100.

That is, the two domains 100 and 200 may include common information of a dynamic triggering command header.

In such a lawful interception apparatus, a business of the service domain 100 delegates an interception right to a business of the IP-CAN domain 200 in case that businesses of the service domain 100 and the IP-CAN domain 200 are different from each other, and the business of the service domain 100 can delegate the interception right to the IP-CAN domain 200 even when the business of the IP-CAN domain 200 is changed as the user terminal UE moves.

In such an IMS, generation and access of sessions and message exchanges for the IMS service are mostly performed through the SIP.

Accordingly, the P-CSCF 311 and S-CSCF 313 according to an exemplary embodiment of the present invention perform delegation of lawful interception right by capturing the SIP message.

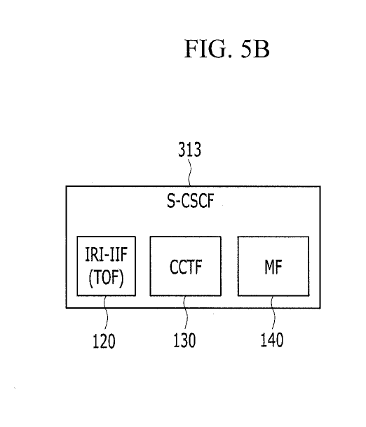

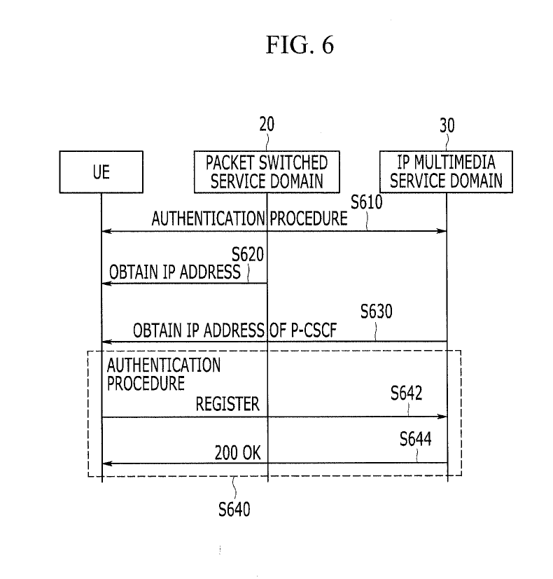

Now, a lawful interception method in the IMS will be described in detail with reference to FIG. 6 to FIG. 12.

First, several preconditions for the user should be satisfied before all services related with the IMS are performed.

FIG. 6 is a drawing illustrating a precondition to use an IMS service.

Referring to FIG. 6, an IP multimedia service domain 30 should perform an authentication procedure to a user terminal UE to authenticate the user terminal UE that wishes to use the IMS service.

Next, the user terminal UE accesses a packet switched service domain 20 to obtain an IP address (S620).

Generally, the IP address is dynamically allocated from a packet switched service domain 20 for a predetermined period.

The packet switched service domain 20 provides information on accesses of a home network of the current user terminal UE or an IMS network of another terminal.

After satisfying the above two preconditions, the user terminal UE obtains an IP address of the P-CSCF 311 that acts as a SIP proxy server through which all SIP messages pass (S630).

The user terminal UE that obtained an IP address of the P-CSCF 311 can send an IP signal to the P-CSCF 311 or receive one from the P-CSCF 311.

During the registration period to receive the IMS service, an IP address of the P-CSCF 311 is permanently allocated.

When all the conditions are satisfied, the user terminal UE initializes all other SIP signals, and is registered in an IMS network at a SIP application level to receive the SIP signal (S640).

Since the IMS was modeled at another layer, a packet switched service domain 20 is independent from an IMS application layer.

Accordingly, a registration procedure in the IMS should be independent from that of the packet switched service domain 20.

That is, the user terminal UE requests a SIP registration by sending a SIP registration (referred to as “REGISTER” hereinafter) message to the IP multimedia service domain 30 (S642), and is registered in the IMS network by receiving a response message (200 OK) from the IP multimedia service domain 30 (S644).

By doing this, the user terminal UE is completely registered in the IMS network, and the user terminal UE can be provided with the IMS service.

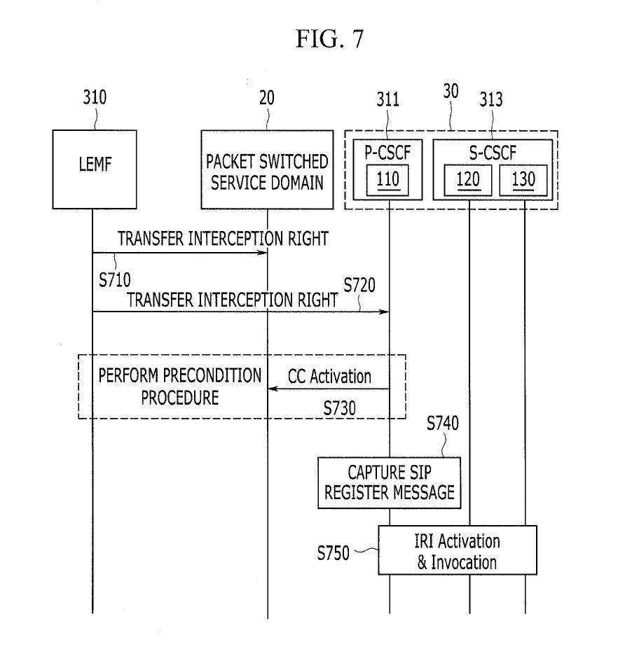

FIG. 7 is a drawing illustrating interception activation in a lawful interception method according to an exemplary embodiment of the present invention.

Referring to FIG. 7, the LEMF 310 provides the packet switched service domain 20 and the IP multimedia service domain 30 with an interception right (S710 and S720).

The AF 110 of the P-CSCF 311 of the IP multimedia service domain 30 obtains an IP address of the user terminal UE while the user terminal UE to be intercepted performs the preconditions to the user of the IMS service, and transfers an interception activation command of the CC (CC Activation) to the packet switched service domain 20 in the state that an interception right has been transferred to the packet switched service domain 20 to which the user terminal UE belongs (S730).

The interception activation command of the CC (CC Activation) may include warrant IDs, command types, dynamic triggering correlation numbers to identify a number of interception contents, identifiers to be intercepted, time when the commands were made, and interception time limit information.

Further, The AF 110 of the P-CSCF 311 captures the ‘REGISTER’ message used when the user terminal UE performs a registration procedure to the IMS network among the preconditions to use the IMS service (S740), and registers a URI of the user terminal UE in the registrar server.

The AF 110 of the P-CSCF 311 transfers an interception activation and invocation command of the IRI (IRI Activation & Invocation) to the CCTF unit 120 through the IRI-IIF unit 120 of the S-CSCF 313 by capturing the SIP registration message (S750).

The interception activation and invocation command of the IRI (IRI Activation & Invocation) may also include warrant IDs, command types, dynamic triggering correlation numbers to identify a number of interception contents, identifiers to be intercepted, time when the commands were made, and interception time limit information.

The interception activation of IRI and CC activates the unit to intercept the IRI and CC to perform an interception, and may include a legal interception right, that is, activation of an interception warrant.

An interception invocation command of the IRI (IRI Invocation) is a task to invocate interception of an actual IRI by applying correct identifier information to be intercepted to an activated warrant.

The packet switched service domain 20 activates the interception through the interception activation of CC (CC Activation) after an object to be intercepted internally obtains an IP address.

Since the session has not yet been formed in the IMS service, actual communication content is not generated so that the packet switched service domain 20 does not invocate the interception of CC but activates it.

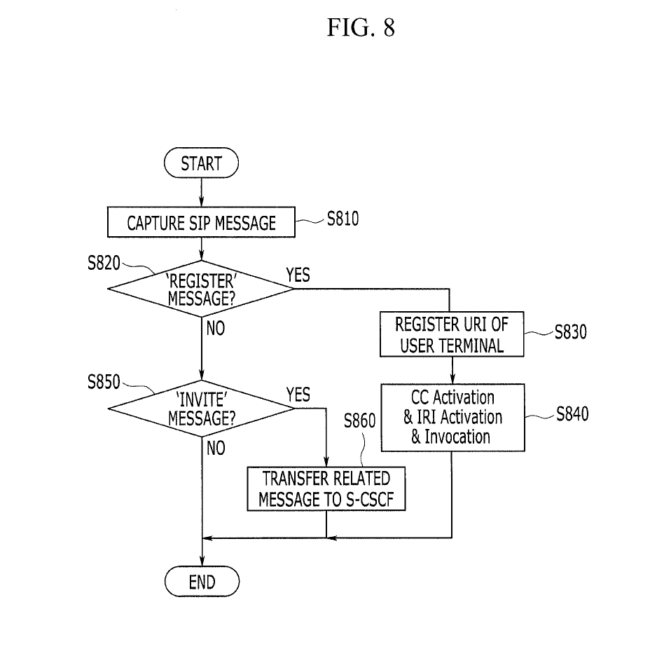

FIG. 8 is a process flowchart of a SIP message to perform interception activation in an AF of a P-CSCF according to an exemplary embodiment of the present invention.

Referring to FIG. 8, after the precondition procedure for the IMS service has been performed in the user terminal UE, the AF 110 of the P-CSCF 311 captures the SIP message occurring in the user terminal UE (S810).

When the captured SIP message is ‘REGISTER’ (S820), the AF 110 of the P-CSCF 311 registers the URI of the user terminal UE (S830), and commands an interception right activation of CC (CC Activation) and an interception activation and invocation of IRI (IRI Activation & Invocation) (S840).

Meanwhile, when the captured SIP message is ‘INVITE’ (S850), the AP of the P-CSCF 311 transfers the SIP message to the S-CSCF 313 to perform the related interception function (S860).

Pseudo codes to perform the function are as in the following Table 1.

TABLE 1

| Void P-CSCF(sip_msg) | |
|---|---|
| { | |
| IMS_Init( ); //Perform precondition procedure for IMS service | |
| Switch(sip_msg) | |
| { | |
| case ‘REGISTER’; | |
| IMS_register(sig_msg.URI) | //Register IMS user URI |
| AF.LI_CC_Activation( ) | //Activate CC interception right |
| AF. LI_IRI_Activation&Invocation( ); //Activate IRI interception right | |
| case INVITE: | |
| S-CSCF(sip_msg); | //Transfer message to S-CSCF function |

}
}

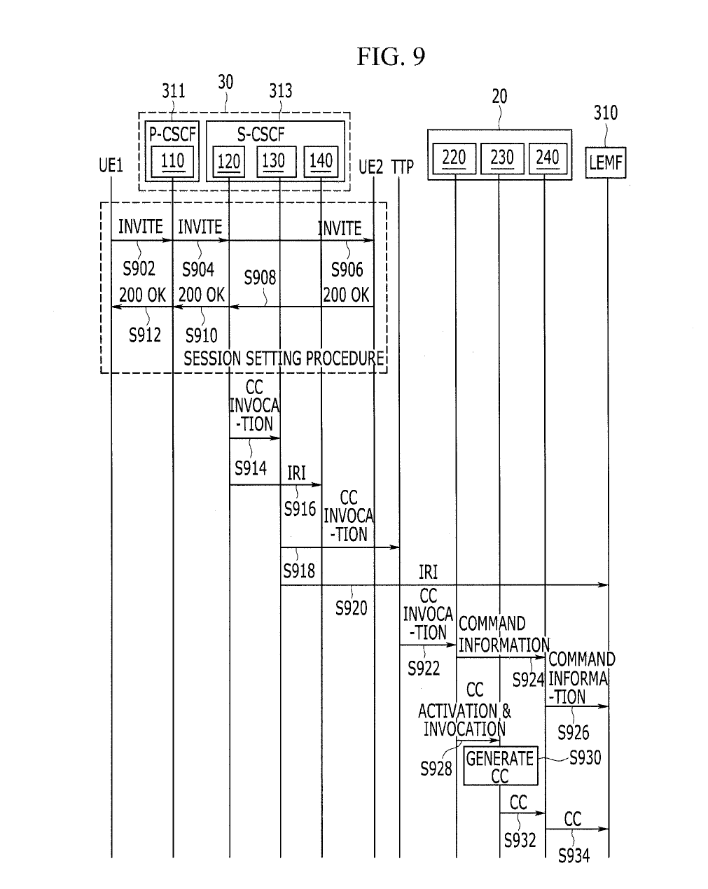

FIG. 9 is a drawing illustrating an IMS-based interception implementation method according to an exemplary embodiment of the present invention.

In FIG. 9, while the packet switched service domain 20 should exist between a user terminal UE1 to be intercepted and the P-CSCF 311, the packet switched service domain 20 is disposed in the right side of the drawing in order to make a description with reference to the standard based interception message flow.

The S-CSCF 313 is a core SIP server to control a session, and has a capacity to perform both TOF and CCTF among interception functions and is in charge of intercepting the session setting (INVITE) message and delegating an interception right in real-time.

Since the S-CSCF 313 maintains subscriber information downloaded from the HSS 32, it can embody an MF in the IMS and then transfer information of the user terminal UE1 to be intercepted to the LEMF 310.

Further, since the S-CSCF 313 can intercept initiation and termination of the session and the path of the SIP message through a continuous user agent function (B2BUA), it can continue to transfer the interception result data to the LEMF 310.

Referring to FIG. 9, the user terminal UE1 to be intercepted registers its own URI through the ‘REGISTER’ message and then transfers a SIP session predetermined (referred to as “INVITE” hereinafter) message to the AF unit 110 of the P-CSCF 311 (S902), and the AF unit 110 of the P-CSCF 311 transfer the INVITE message to the counterpart terminal UR through the IRI-IIF unit 120 of the S-CSCF 313 to request communication to the counterpart terminal UE2 (S904-S906).

After that, the user terminal UE1 receives a response message to the INVITE message from the counterpart terminal UE2 through the IRI-IIF unit 120 of the S-CSCF 313 and the AF unit 110 of the P-CSCF 311 and predetermines a session with the counterpart terminal UE2 (S908-S912).

The request URI (Request-URI) header of the INVITE message includes a URI of the counterpart terminal UE2, and a contact header includes a URI of the user terminal UE1 to be intercepted.

At this time, since the S-CSCF 313 has the URI to be intercepted through the REGISTER message, the IRI-IIF unit 120 intercepts the INVITE message in the S-CSCF 313 and commands the interception invocation of CC (CC Invocation) in real-time through the TOF unit of the IRI-IIF unit 120 (S906).

In detail, the IRI-IIF unit 120 transfers the interception invocation (CC Invocation) command to the CCTF unit 130 (S914), and the CCTF unit 130 transfers the interception invocation of CC (CC Invocation) and a network business identifier to be intercepted that indicates the packet switched service domain 20 to the TTP (S918).

The interception invocation of CC (CC Invocation) command may also include warrant identifiers, command types, dynamic triggering correlation number to identify a plurality of interception contents, identifiers to be intercepted, time when the commands were made, and interception time limit information.

Further, the IRI-IIF unit 220 can generate an IRI related with the object to be intercepted in the IP multimedia service domain 20, and transfer the IRI to the LEMF 310 through the MF unit 140 (S916 and S920).

The IRI-IIF unit 220 can transfer an actual SIP message to the LEMF 310 through the interface TO1a.

The TTP verifies whether the interception invocation of CC (CC Invocation) received is valid and the packet switched service domain 20 that will transfer the interception invocation command of CC can perform the command, and then transfers the interception invocation command of CC (CC Invocation) to the CCTF unit 220 of the packet switched service domain 20 (S922).

The CCTF unit 220 that received the interception invocation command of CC (CC Invocation) transfers the interception activation and invocation command of CC (CC Activation & Invocation) to the TRF unit of the CC-IIF unit 220 (S928).

Further, the CCTF unit 220 transfers information on the interception invocation command of CC to the LEMF 310 through the MF unit 240 (S924 and S926).

The TRF unit of the CC-IIF unit 220 receives the interception activation and invocation command of the CC (CC Activation & Invocation), and the CC-HF unit 220 generates the CC related with the object to be intercepted and transfers the CC to the LEMF 310 through the MF unit 240 (S930-S934).

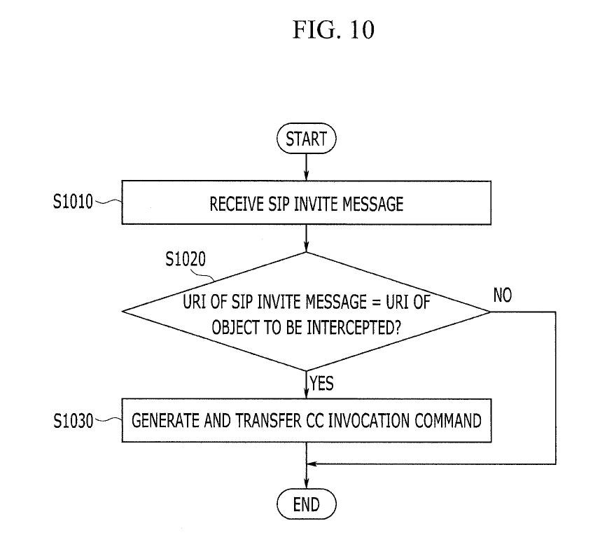

FIG. 10 is a process flowchart of a SIP message to perform communication content interception implementation in an S-CSCF according to an exemplary embodiment of the present invention.

Referring to FIG. 10, when the S-CSCF 313 receives the INVITE message among SIP messages (S1010), it determines whether the URI included in the INVITE message and the URI to be intercepted are identical to each other (S1020).

At this time, if the URI included in the INVITE message and the URI to be intercepted are identical to each other, the S-CSCF 313 generates the interception invocation command of the CC (CC Invocation) in real-time and transfers the command to the TTP (S1030).

The TTP verifies whether the interception invocation command of the CC (CC Invocation) received is valid and the packet switched service domain 20 to which the interception invocation command of CC will be transferred can perform the command, and then transfers the interception invocation command of CC (CC Invocation) to the packet switched service domain 20.

The packet switched service domain 20 that has received the interception invocation command of the CC (CC Invocation) from the TTP performs the interception invocation of the actual CC (communication content).

Pseudo codes to perform such a function are as in the following Table 2.

TABLE 2

```
Void S-CSCF(sip_msg)
{
    If(sip_msg.URI == Target_URI {
    //Transfer DT commant and URI of target to CCTF through CCTI interface
    TOF.CCTI(CMD_Invocation.Target_URI);
    //Transfer user information(IRI) to MF through INI2
    IRI_IIF.INI2(getProfile(Target_URI));
    //Transfer actual sip packets to MF through TO1a
    IRI-IIF.TO1a(CMD_Invocation.getIPCAN_ID(Target_URI. IP).sip_msg);
    //Transfer user information (IRI) to LEMF through HI2
    IRI-IIF.HI2(INI2_msg);
    //Transfer DT commant and network business ID of target to TTP through
CCTIGI&CCTFGID2
    If(CCTF.CCTIGI&CCTFGID2(CMD_Invocation.getIPCAN_ID(Target_URI.IP))==TRUE
) {
    //Transfer actual sip packets to LEMG through TO1b
    MF.TO1b(TO1a.msg);
    }else {
    MF.TO1b(error_msg);
    }
  }
  Bool TTP(DT_Command.IPCAN_ID)
  {
    // Perform DT of DT command is valid and business of network to be transferred
embodied DT
    if(validate(DT_Command)==TRUE&&DTimplement(IPCAN_ID)==TRUE)
      TTP.CCTFGID3&CCTIGR(CMD_Invocation.IPCAN_ID);
        Return TRUE;
      else
      return FALSE & error_msg;
```

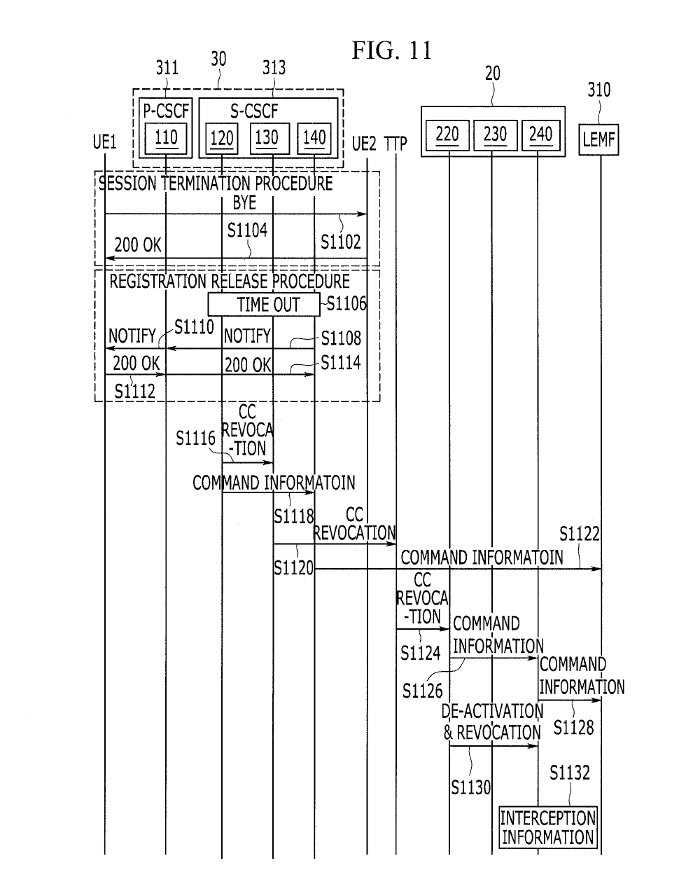

FIG. 11 is a drawing illustrating an IMS-based interception termination method according to an exemplary embodiment of the present invention.

Referring to FIG. 11, when the user terminal UE1 to be intercepted terminates the communication session, it does not pass through the P-CSCF 311 or S-CSCF 313 but directly transmits a session termination message (referred to as a “BYE message” hereinafter) to the counterpart terminal UE2 (S1102), differently from the REGISTER message used to register the URI of the user terminal UE1 or the INVITE message to predetermine the session, and receives a response (200 OK) from the counterpart terminal UE2 to terminate the session (S1104).

Accordingly, it is not possible to intercept the termination of the session through the BYE message with the interception functions of the P-CSCF 311 and S-CSCF 313.

However, when there is continuous communication between the user terminal UE1 and the counterpart terminal UE2, the user terminal UE1 performs a re-registration procedure in the same order as the registration procedure in the S-CSCF 313 in a predetermined period in order to update the registration state each time the expiration time designated through the first REGISTER message expires.

When the session in the user terminal UE1 is terminated thorough the BYE message, the timer is timed out (S1106), and when the registration state of the user terminal UE1 is no longer updated, the S-CSCF 313 transfers the session termination message (referred to as “NOTIFY message” hereinafter) indicating the session termination, among the SIP messages to the AF unit 110 of the P-CSCF 311 (S1108).

The AP unit 110 of the P-CSCF 311 transfers the NOTIFY message to the user terminal UE1 again (S1110).

Then, when the S-CSCF 313 receives a response (200 OK) message to the NOTIFY message from the user terminal UE1 through the AF unit 110 of the P-CSCF 311, it releases all related sessions.

Accordingly, when a time out belonging to the IP multimedia service domain 20 occurs, the IRI-IIF unit 120 captures the NOTIFY message and commands the interception revocation (CC Revocation).

The interception revocation command (CC Revocation) is a command to remove the identifier that is currently intercepted from the TRF unit.

In detail, the IRI-IIF unit 120 transfers the interception revocation command (CC Revocation) to the CCTF unit 130 (S1116), and the CCTF unit 130 transfers it to the CCTF unit 220 of the packet switched service domain 20 through the TTP (S1120, S1124).

Further, the CCTF unit 130 may transfer the interception revocation command (CC Revocation) information to the LEMF 310 through the MF unit 140 (S1118, S1122).

When the CCTF unit 220 of the packet switched service domain 20 receives the interception revocation command (CC Revocation) (S1124), it transfers the interception revocation command (CC Revocation) information to the LEMF 310 through the MF unit 240 (S1126, S1128), and transfers the interception right de-activation and interception revocation command of the CC (CC De-Activation & Revocation) to the TRF unit of the CC-IIF unit 230 (S1130).

The TRF unit of the CC-IIF unit 230 removes the identifier to be intercepted by the interception revocation (CC Revocation) to terminate all interception activities related with the interception warrant (S1132).

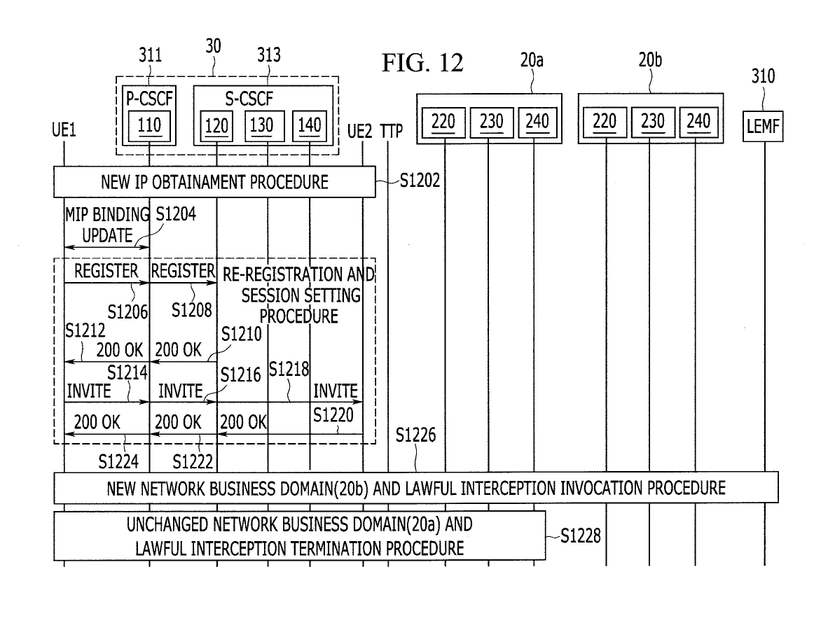

FIG. 12 is a drawing illustrating another embodiment of an IMS-based lawful interception method according to an exemplary embodiment of the present invention.

FIG. 12 illustrates a method to activate and invocate the interception right in a case that a network business has changed from a packet switched service domain 20a to a packet switched service domain 20b as the object to be intercepted moves, and a method to terminate the interception in the packet exchange service domain 20a in a case that the network business has not yet changed.

Referring to FIG. 12, in a case that the network business has changed from the packet switched service domain 20a to the, packet switched service domain 20b as the object to be intercepted moves, the user terminal UE1 performs a new IP obtainment procedure with a new packet switched service domain 20b (S1202).

As the user terminal UE1 that uses the IMS service moves, the network business domain accessed is changed and then a change occurs in the IP.

The user terminal UE1 that is allocated with a new IP performs a binding update procedure with the P-CSCF 311 to notify an IP multimedia service domain that the IP was changed (S1204).

Next, the user terminal UE1 performs user re-registration and a predetermined session procedure with the IP multimedia service domain 30.

As described above, the user terminal UE1 transfers the REGISTER message to the P-CSCF 311 and then the P-CSCF 311 transfers the REGISTER message to the S-CSCF 313 (S1206, S1208).

Then, the user terminal UE1 receives the response (200 OK) message for the REGISTER message from the S-CSCF 313 through the P-CSCF 311 (S1210, S1212) to complete the re-registration.

Further, the user terminal UE1 transfers the INVITE message to the P-CSCF 311 and the P-CSCF 311 transfers the INVITE message to the S-CSCF 313 (S1214 and S1216), and the S-CSCF 313 transfers the INVITE message to the counterpart terminal UE2 again (S1218).

Then, the user terminal UE1 receives a response (200 OK) message to the INVITE message from the counterpart UE2 through the S-CSCF 313 and P-CSCF 311 (S1220-S1224) to complete the session setting.

At this time, in a case that the user terminal UE1 normally terminates the session, moves to another packet switched service domain 20b, and then uses the IMS service, it can register the user terminal UE1 again on the basis of the changed IP address and set the session.

In such a case, since the session setting of the IMS service has been terminated already and the interception has also been terminated, interception activation should be performed in advance, and such procedures are omitted.

Meanwhile, there also is a case where the service domain is changed into the packet switched service domain 20b due to the fact that the user terminal UE1 moves in the state that the session has already been set so that communication is performed.

In this case, while communication between the packet switched service domains 20a and 20b is continuously performed, since it is not possible to recognize the changed IP in case of interception, it is not possible to monitor the unchanged packet switched service domain 20a.

At this time, the IMS 33 updates the session setting that is currently communicated using a re-session setting message (referred to as “RE-INVITE message”) instead of the INVITE message.

Finally, a procedure to invocate the lawful interception to the packet switched service domain 20b is performed (S1226), and a procedure to terminate the lawful interception to the unchanged packet switched service domain 20a is performed (S1228).

The procedure to invocate the lawful interception is similar or identical to the method described with reference to FIG. 9, and the IRI-IIF unit 120 invocates interception of a new packet switched service domain 20b on the basis of the IP address changed by capturing the INVITE and/or RE-INVITE message.

Further, the procedure to terminate the interception may be similar or identical to the method described with reference to FIG. 11.

That is, an interception command may be sent to a new packet switched service domain 20b and then an interception revocation command may be sent to the packet switched service domain 20a.

In order to have continuous interception, firstly, an interception invocation procedure of the packet switched service domain 20b is performed, and then, when interception of an actual CC is invocated (CC Network Provider 2 Activation & Invocation), the IRI-IIF unit 120 of the IP multimedia service domain 30 may transfer the interception revocation message (CC Revocation) to the packet switched service domain 20a.

In a case that the session was already set and the communication is being performed, when the user terminal UE1 performed a re-registration with a new IP, the AP unit 110 of the IP multimedia service domain 30 senses the REGISTRATION message and performs the interception procedure in advance before the session setting is performed, or performs the interception procedure and the session setting procedure in parallel so that continuous interception may be invocated.

According to an exemplary embodiment of the present invention, an interception right is delegated between an IP multimedia service business and a packet switched network service on an IMS and a continuous interception right delegation is provided among various packet switched network service businesses, whereby a lawful interception can be efficiently performed.

The exemplary embodiments of the present invention are not only embodied through the apparatus and/or method described above, but may be embodied through a program that embodies functions corresponding to constructions of the exemplary embodiment of the present invention or a recording medium, wherein such embodiment may be implemented by those skilled in the art from the description of the exemplary embodiment.

Hereinbefore, while an exemplary embodiment of the present invention has been described in detail, the scope of right of the present invention is not restricted thereto and various modifications and improvements that those skilled in the art may make using basic concepts of the present invention defied in the following claims are also included in the scope of right of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for performing a lawful interception in an IP multimedia
subsystem, wherein an IP multimedia service domain and a network service domain are separated each other, the method comprising:
capturing a SIP message transmitted from a terminal that uses an IMS service to be intercepted, and
determining at least one of activation, invocation and termination of the lawful interception of the terminal to be intercepted using the SIP message.

2. The method of claim 1, wherein the determining includes
registering a URI (uniform resource identifier) of the terminal to be intercepted when a SIP registration message, used to register the terminal to be intercepted into the IP multimedia service domain by the terminal to be intercepted, was captured, and
activating the lawful interception.

3. The method of claim 2, wherein the SIP registration message is captured in a P-CSCF (proxy-call session control function) of the IP multimedia subsystem.

4. The method of claim 2, wherein the activating includes
invocating an interception of interception related information (IRI) and transferring the intercepted information to an interception monitoring apparatus, and
activating an interception of CC (content of communication).

5. The method of claim 2, wherein the determining includes
invocating the lawful interception in a case that a SIP session setting message used to set session for an IP multimedia service of the terminal to be intercepted was captured.

6. The method of claim 5, wherein the SIP session setting message is captured in an S-CSCF (serving-CSCF) of the IP multimedia subsystem.

7. The method of claim 6, wherein invocating includes
transferring an interception invocation command to the network service domain in the S-CSCF.

8. The method of claim 7, wherein the implementing further includes
intercepting the CC in the network service domain and transferring the CC to the interception monitoring apparatus in the network service domain.

9. The method of claim 2, wherein the determining includes
capturing a SIP session termination message indicating a termination of session, thereby terminating the lawful interception, in the S-CSCF (serving-CSCF) of the IP multimedia subsystem.

10. The method of claim 9, wherein the terminating includes
transferring the SIP session termination message to the terminal to be intercepted, the S-CSCF, through the P-CSCF in a case that a timer corresponding to an expiration time allocated in the first SIP registration message is timed out and a re-registration is not performed, and
capturing the ISP NOTIFY message in the S-CSCF.

11. The method of claim 10, wherein the terminating further includes
generating an interception termination command and transfer the command to the network service domain in the S-CSCF in a case that the S-CSCF has captured the SIP NOTIFY message.

12. The method of claim 1, wherein the determining further includes
activating and invocating the lawful interception of a changed network service domain in a case that the network service domain is changed as the user terminal moves, and
terminating a lawful interception of the unchanged network service domain.

13. The method of claim 12, wherein the activating and invocating further include
capturing a SIP session resetting message and invocating the lawful interception in a case that the user terminal moves in the state of communication.

14. An apparatus for performing a lawful interception in an IP multimedia subsystem in which an IP multimedia service domain and a network service domain are separated from each other, the apparatus comprising:
an interception administration function unit to capture a first SIP message of a user terminal to be intercepted and transfer an activation command of a lawful interception;
an interception information internal collection function unit to generate a user terminal related IRI according to an activation command of the lawful interception and transfer the IRI to an interception monitoring apparatus, capture a second SIP message of the user terminal and command invocation of the lawful interception, and capture a third SIP message of the user terminal and command termination of the lawful interception; and
an interception content trigger function unit to transfer invocation and termination of the lawful interception to the network service domain.

15. The apparatus of claim 14, wherein the interception administration function unit is included in a P-CSCF (proxy-call session control function) of the IP multimedia subsystem.

16. The apparatus of claim 14, wherein the interception information internal collection function unit and the interception content trigger function unit are included in the S-CSCF (serving-CSCF) of the IP multimedia subsystem.

17. The apparatus of claim 14, further comprising
an interception content internal collection function unit to intercept the communication content according to an invocation of the lawful interception and transfer the communication content to a monitoring apparatus, and to terminate the lawful interception according to the termination of the lawful interception,
wherein the interception content internal collection function is included in the in the network service domain.

18. The apparatus of claim 14, wherein the first message includes a SIP registration message used when the user terminal is registered in the IP multimedia service domain.

19. The apparatus of claim 14, wherein the second message includes a SIP session initiation message or a SIP session resetting message used when the user terminal sets a session for the IP multimedia service.

20. The apparatus of claim 14, wherein the third SIP message includes a SIP termination message used in a case that a re-registration is not performed in the IP multimedia service domain when an expiration time designated in the SIP registration message is timed out.
